(19) United States
(12) Patent Application Publication
(10) Pub. No.: US 2025/0252000 A1
(43) Pub. Date: Aug. 7, 2025

(54) MESSAGE PRIORITIZATION FOR EVENT-BASED SYSTEMS

(71) Applicant: Dell Products L.P., Round Rock, TX (US)

(72) Inventors: Sriharsha D V, Bangalore (IN); Kishore Gr, Mysore (IN); Robert J. Bell, IV, Forest City, NC (US); Gouri Shankar Mohapatra, Baripada Town (IN)

(21) Appl. No.: 18/435,420

(22) Filed: Feb. 7, 2024

(51) Int. Cl. G06F 9/54

(52) U.S. Cl. CPC G06F 9/546; G06F 9/542

(57) ABSTRACT

Methods, apparatus, and processor-readable storage media for prioritizing messages in event-based systems are provided herein. An example computer-implemented method includes obtaining information indicating priority types of a first set of messages to be processed by a message processing platform, where the first set of messages is provided to the message processing platform in response to an occurrence of an event. The process includes changing a state of the message processing platform from a first state to a second state based on the information, wherein the second state at least partially suspends processing of a second set of messages. The process also includes processing the first set of messages based on the priority types of the messages in the first set and changing the state to the first state based on the first set of messages being processed.

### BACKGROUND

A number of scenarios exist where multiple services need to store, update and/or access information. For example, some systems use a publish-subscribe model to communicate information, where subscriber applications and/or services can obtain messages from publisher applications and/or services by subscribing to certain categories or topics.

### SUMMARY

Illustrative embodiments of the disclosure provide techniques for prioritizing messages in event-based systems. An exemplary computer-implemented method includes obtaining information indicating one or more priority types of a first set of one or more messages to be processed by a message processing platform, where the first set of messages is provided to the message processing platform in response to an occurrence of at least one event. The method includes changing a state of the message processing platform from a first state to a second state based on the information, where the second state at least partially suspends processing of at least a second set of one or more messages by the message processing platform, and processing the first set of messages in an order determined based at least in part on the one or more priority types of the messages in the first set. The method also includes changing the state of the message processing platform from the second state to the first state based at least in part on the first set of messages being processed.

Illustrative embodiments can provide significant advantages relative to conventional techniques. For example, technical problems associated with consistency of data in event-based systems are mitigated in one or more embodiments by applying different message processing states to process messages based on different priorities.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for prioritizing messages in event-based systems in an illustrative embodiment.

FIG. 2 shows an example of a priority message table in accordance with an illustrative embodiment.

FIG. 3 shows a flow diagram of a process for detecting priority events in accordance with an illustrative embodiment.

FIG. 4 shows a flow diagram of a process for trigging a priority state in accordance with an illustrative embodiment.

FIG. 5 shows a flow diagram for processing event messages in a first message state in accordance with an illustrative embodiment.

FIG. 6 shows a flow diagram for processing event messages in a second state in accordance with an illustrative embodiment.

FIG. 7 shows a flow diagram of a process for prioritizing messages in event-based systems in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Event-based systems, including event-streaming platforms, are often implemented using a publish-subscribe message model. For example, an event-streaming platform can include functionality for publishing, and subscribing to, event streams, as well as for storing and processing events related to such event streams. In such systems, event producers can correspond to applications or services that assign data (e.g., in the form of messages) to topics, and event consumers can correspond to applications or services that read data from such topics. The term “service” in this context and elsewhere herein is intended to be broadly construed, so as to encompass, for example, a software mechanism that performs one or more functions or tasks, typically, such as web services, microservices, as well as other types of software services.

Accordingly, an event stream can refer to sequences of events that flow from event publishers to event subscribers. A given event-based system can be implemented as a distributed system comprising a cluster of servers (referred to as message brokers) that coordinate with one another to read, write, and process streams of events, for example.

Event-based systems typically include a microservice, a message queue, and possibly other tools for managing how messages are queued and processed. It is important that the microservice remains synchronized with changes to critical data before processing further events, such as changes related to passwords, infrastructure downtimes, configuration updates, and/or other types of service behavior-altering events. Existing event-based systems generally do not include a mechanism to ensure these changes are synchronized, which can result in errors and/or data inconsistency.

In one or more embodiments, techniques are provided for a prioritized message processing service. The prioritized message processing service, in some embodiments, can prioritize one or more types of events for processing and temporarily prevent other types of events from being processed. Such embodiments can handle errors more effectively, improve data consistency, and increase overall system reliability relative to conventional techniques.

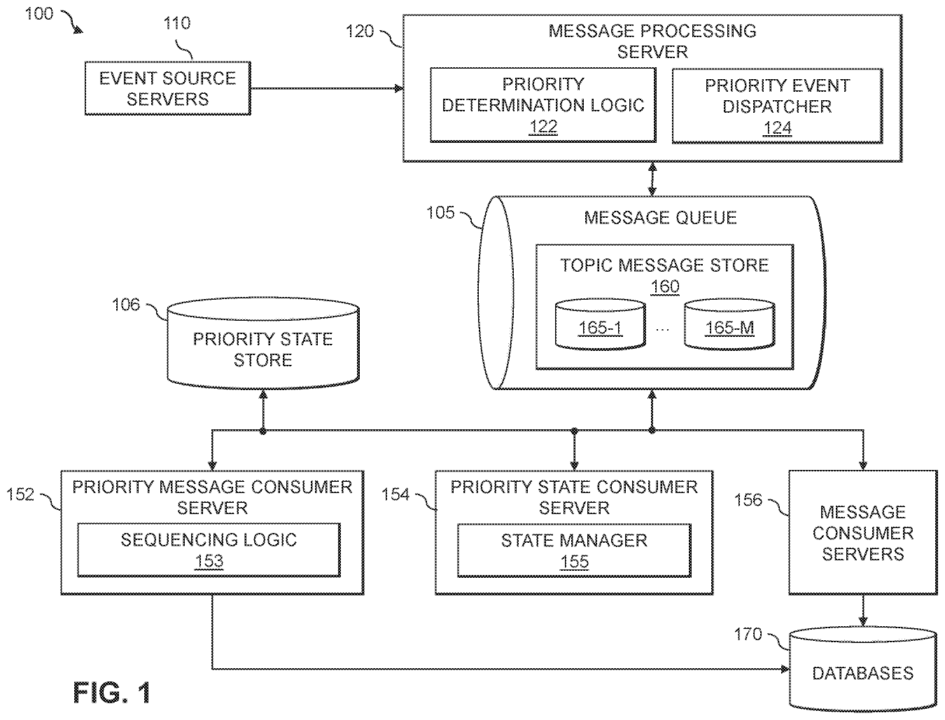

FIG. 1 shows an information processing system 100 configured for prioritizing messages in event-based systems in accordance with an illustrative embodiment. The exemplary information processing system 100 comprises one or more event source servers 110, a message processing server 120, a priority message consumer server 152, a priority state consumer server 154, and one or more message consumer servers 156. The information processing system 100 further comprises a message queue 105, a priority state store 106, and one or more databases 170, discussed below.

In the example of FIG. 1, event source servers 110 provide one or more event messages to the message processing server 120 in response to an occurrence of one or more corresponding events on event source servers 110. For example, the event source servers 110 may execute one or more services and/or one or more applications that send event-based messages to another service or application. The event source servers 110 may be associated with a software development service, a project management service, a continuous integration tool, a data monitoring service and/or a hardware monitoring service, and/or other types of services or tools that provide event messages in response to occurrence of events. Generally, an event message records the fact that an event has happened, typically with respect to an operation of one of the event source servers 110, and can include a key, a value, a timestamp, and optional metadata. Producers are those services or applications that publish (e.g., write) event messages to the message queue 105, and consumers are those services or applications that subscribe to (e.g., read and process) such published event messages from the message queue 105.

The event source servers 110 may be configured, in at least some embodiments, to send information for events to the message processing server 120. The message processing server 120 comprises priority determination logic 122 and a priority event dispatcher 124. The priority determination logic 122 obtains event messages and determines whether a given one of the event messages corresponds to a priority event. For example, the priority determination logic 122 can determine whether the event messages correspond to at least one of a plurality of priority event types. In some embodiments, the plurality of priority event types can include, for example, downtime events, password change events, configuration change events, and/or user priority events. For example, the priority determination logic 122 can determine whether at least some of the event messages correspond to a particular priority event type based on one or more naming conventions. At least one of the event source servers 110 can assign different identifiers to different priority types, and these identifiers can be included as part of the event messages, as a non-limiting example.

According to some embodiments, if there are no priority events detected by the priority determination logic 122, then the priority determination logic 122 processes the event messages in a normal message state (also referred to herein as a first message state), for example, by dispatching the event messages to the message queue 105.

The message queue 105 may be implemented, for example, as part of an event-streaming platform (such as a Kafka distributed event streaming platform, a Pulsar distributed messaging system, or using RabbitMQ message-oriented middleware). In some embodiments, the message queue 105 supports publishing (e.g., writing) streams of events and subscribing to (e.g., reading) the published streams of events. The message queue 105 may also store the streams of events durably and reliably. A message storage service (not shown in FIG. 1) associated with the message queue 105 (e.g., a broker when the message queue 105 is implemented as a Kafka distributed event streaming platform or a bookkeeper when the message queue 105 is implemented as a Pulsar distributed messaging system) may publish the published event messages to one or more topics 165-1 through 165-M associated with the message queue 105, collectively referred to herein as topics 165, as part of a topic message store 160.

The message storage service associated with the message queue 105 may also notify one or more of the message consumer servers 156 of the availability of new published event messages on the message queue 105. In some embodiments, the message storage service will notify those message consumer servers 156 that subscribed to any of the topics 165 where the new published event messages were published. In a further variation, the message consumer servers 156 can look for new published event messages on the message queue 105.

In addition, one or more of the message consumer servers 156 may place a new event message in a database 170. For example, the database 170 can comprise a query interface that allows the event messages in the database 170 to be queried, for example, using SQL (Structured Query Language) queries, and to provide query results. In this manner, the event messages may be accessed by (and made available to) database-centric consumers.

Accordingly, while in the first message state, the one or more message consumer servers 156 can consume the published event messages in the message queue 105 based on the corresponding topics 165.

In some embodiments, if the priority determination logic 122 determines that one or more of the event messages correspond to one or more types of priority events, then the priority event dispatcher 124 can generate and send information indicating that a priority event has occurred. For example, the information can comprise a priority signal message that includes metadata indicating a source of the priority event. As a non-limiting example, the format of the priority signal message can include a topic name and a priority topic.

In response to the information sent by the priority event dispatcher 124, the priority state consumer server 154 can change the state from the first message state to a priority state (also referred to as a second state). It is assumed that the priority message consumer server 152, the priority state consumer server 154, and at least a portion of the message consumer servers 156 can determine whether the state is set to the first message state or the second message state. The message state can be maintained as a constructor variable or an in-memory service level variable, as non-limiting examples. In at least some embodiments, the priority state consumer server 154 includes a state manager 155 for creating a priority state table in response to the priority signal message. The priority state table can be maintained as a dictionary in the priority state store 106 by the state manager 155, for example.

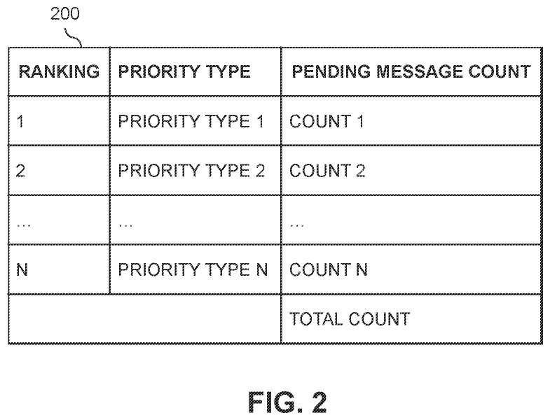

Referring also to FIG. 2, this figure shows an example of a priority state table 200 in accordance with an illustrative embodiment. The priority state table 200 includes a ranking field, a priority type field, and a pending message count field. In this example, the priority state table 200 includes a plurality of priority types 1-N having respective rankings 1-N. As a non-limiting example, the priority types can include downtime events, alert events, password events, configuration change events, and user priority request events, and the priority events can be ranked in that order. It is to be appreciated that other ranking schemes may also be used, including ranking schemes with additional and/or different types of priority events. The pending message counts of respective priority types in the priority state table 200 can be updated by the state manager 155 as priority event messages are received. For example, priority type 1 can have a corresponding pending message count, referred to in FIG. 2 as “count 1.” A total count can be provided as the sum of the pending message counts for each priority type referenced in the priority state table 200.

In some embodiments, the priority state table 200 can be implemented as a language based dictionary (or map), which can act as a temporary storage in-memory, for example.

It is to be appreciated that in some embodiments the rankings are configurable (e.g., by a user). Alternatively, or additionally, if a same ranking is given to two or more priority types, then a selection scheme can be applied to determine the order between the two or more priority types, such as round robin scheme or a randomized scheme.

In response to the state being set to the second state, the message consumer servers 156 stop consuming event messages, and the priority message consumer server 152 begins consuming priority event messages. In the FIG. 1 embodiment, for example, the priority message consumer server 152 includes sequencing logic 153 that sequences the priority event messages based on the priority rankings. As noted above, the priority state table 200 can include information about the priority event messages and the total counts organized according to the priority ranking, which can be accessed (e.g., read) by the sequencing logic 153. The reading can be based on one or more topics (e.g., from among topics 165), where events are read from the highest priority to the lowest priority. The sequencing logic 153 can determine a priority ranking among the priority events where, for example, higher priority event messages are to be processed before lower priority event messages.

In some embodiments, the priority message consumer server 152 can be subscribed to respective ones of the topics 165 associated with the plurality of priority types. The priority message consumer server 152 can alternatively or additionally subscribe to a single priority topic that corresponds to two or more priority event types, in cases where the type of events can be determined (e.g., based on respective identifiers in the priority event messages).

The priority message consumer server 152 decreases the counts associated with each of the priority types in the priority state table 200 as the priority event messages are processed, and the total count is also decreased accordingly. The priority message consumer server 152 continues to process the priority event messages until there are no priority messages remaining. In response to determining that the total priority event message count is zero, the priority message consumer server 152 can set the priority state back to the first message state. Optionally, the priority message consumer server 152 can place a new priority event message in the database 170 similarly as described above in conjunction with the message consumer servers 156, for example.

The priority state store 106 and/or the database 170 in the present embodiment are implemented using one or more storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

One or more of the message queue 105, priority state store 106, event source servers 110, message processing server 120, priority message consumer server 152, priority state consumer server 154, message consumer servers 156, and database 170 may be coupled to a network, where the network in this embodiment is assumed to represent a sub-network or other related portion of a larger computer network. The network is assumed to comprise a portion of a global computer network such as the Internet, although other types of networks can be part of the computer network, including a wide area network (WAN), a local area network (LAN), a satellite network, a telephone or cable network, a cellular network, a wireless network such as a Wi-Fi or WiMAX network, or various portions or combinations of these and other types of networks. The network in some embodiments therefore comprises combinations of multiple different types of networks, each comprising processing devices configured to communicate using internet protocol (IP) or other related communication protocols.

Also associated with one or more of the event source servers 110, message processing server 120, and/or message consumer servers 156 can be one or more input/output devices (not shown), which illustratively comprise keyboards, displays or other types of input/output devices in any combination. Such input/output devices can be used, for example, to support one or more user interfaces to one or more components of the information processing system 100, as well as to support communication between the components of the information processing system 100 and/or other related systems and devices not explicitly shown.

It is to be appreciated that the term “user” is intended to be broadly construed so as to encompass, for example, human, hardware, software or firmware entities, as well as various combinations of such entities. Compute and/or storage services may be provided for users under a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

One or more of the message queue 105, priority state store 106, event source servers 110, message processing server 120, priority message consumer server 152, priority state consumer server 154, message consumer servers 156, and database 170 illustratively comprise processing devices of one or more processing platforms. For example, a given event source server 110 can comprise one or more processing devices each having a processor and a memory, possibly implementing virtual machines and/or containers, although numerous other configurations are possible.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

At least portions of elements 122 and 124, element 153, and/or element 155 may be implemented at least in part in the form of software that is stored in memory and executed by a processor.

It is to be appreciated that the particular arrangements of elements 122 and 124 illustrated in message processing server 120, element 153 illustrated in the priority message consumer server 152, and element 155 illustrated in the priority state consumer server 154 of the FIG. 1 embodiment are presented by way of example only, and alternative arrangements can be used in other embodiments. For example, the functionality associated with elements 122 and 124, element 153, and/or element 155 in other embodiments can be combined into a single element or a single module, or separated across a larger number of elements or modules. As another example, multiple distinct processors and/or memory elements can be used to implement different ones of elements 122 and 124, element 153, and/or element 155, or portions thereof.

It is to be understood that the particular set of elements shown in FIG. 1 including message queue 105, priority state store 106, event source servers 110, message processing server 120, priority message consumer server 152, priority state consumer server 154, and message consumer servers 156 illustrated in the information processing system 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the message queue 105, priority state store 106, message processing server 120, priority message consumer server 152, priority state consumer server 154, and/or at least a portion of the message consumer servers 156 can be on and/or part of the same processing platform. As another example, the priority state store 106 can be implemented on at least one of the priority message consumer server 152, the priority state consumer server 154, the message consumer servers 156, the message queue 105, or the one or more databases 170. Alternatively, or additionally, at least a portion of the priority message consumer server 152 and/or the priority state consumer server 154 can be implemented on at least one of the message consumer servers 156.

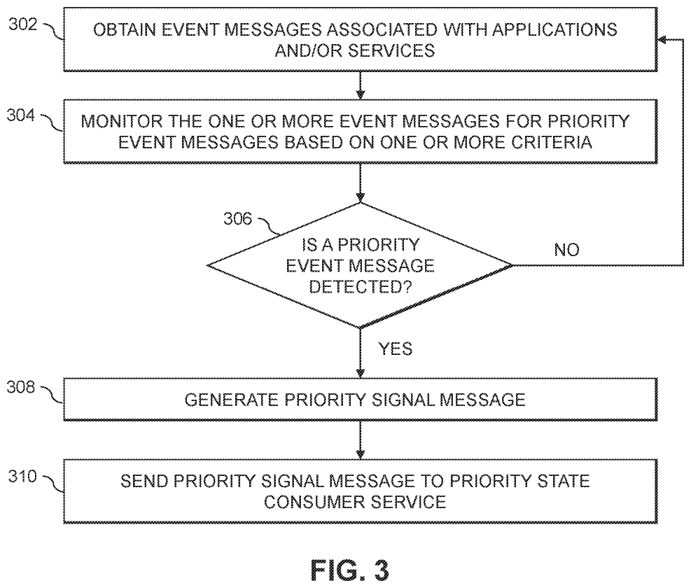

FIG. 3 shows a flow diagram of a process for detecting priority events in accordance with an illustrative embodiment. The process depicted in FIG. 3 can be performed at least in part by the message processing server 120 utilizing its elements 122 and 124.

Step 302 includes obtaining one or more event messages associated with one or more applications and/or services.

Step 304 includes monitoring the one or more event messages for priority event messages based on one or more criteria.

Step 306 includes a test to determine whether a priority event message is detected. If the result of step 306 is yes, then step 308 is performed, which includes generating a priority signal message. Step 310 includes sending the priority signal message to a priority state consumer (e.g., priority state consumer server 154).

If the result of step 306 is no, then the process flow returns to step 302, so that additional event messages can be monitored, for example.

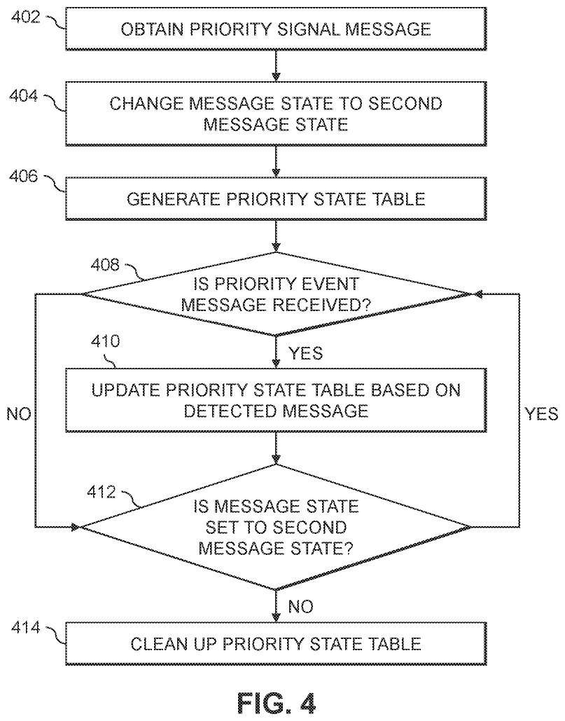

FIG. 4 shows a flow diagram of a process for detecting priority events in accordance with an illustrative embodiment. The process depicted in FIG. 4 can be performed at least in part by the priority state consumer server 154 utilizing it state manager 155.

Step 402 includes obtaining a priority signal message, for example, sent by the message processing server 120 at step 310.

Step 404 includes changing a message state to a second message state.

Step 406 includes generating a priority state table (e.g., such as priority state table 200). The priority signal message may include a type of priority event and a message key corresponding to the priority event. The priority state consumer server 154 can then generate the priority state table based on the message key and the type of the priority event. It is noted that multiple priority signal messages can be received for different types of priority events as they occur. In some embodiments

Step 408 includes a test to determine whether a priority event message is received. For example. If the result of step 408 is yes, then step 410 is performed. Otherwise, the process continues directly to step 412.

Step 410 includes updating the priority state table based on the detected message. For example, the priority state consumer server 154 can determine the priority event message corresponds to a particular type of priority event, and then update the count maintained in the priority state table for that type. As an example, the priority event may be associated with a particular topic (e.g., one of the topics 165) corresponding to a type of priority event (e.g., a password event, a downtime event, etc.). If the type of priority event is present in the priority state table, then the count corresponding to that type can be updated (e.g., incremented by one). If the type of priority event is not present in the priority state table, then a new entry can be added in the priority state table. A rank for the new entry can also be added based on a default set of rankings or a configurable set of rankings for different types of priority event, as discussed elsewhere herein. Step 412 is another test to determine whether the message state is still set to the second message state. If yes, then the process returns to step 408 to determine if any (further) priority event messages are received. If the message state is not set to the second state, then step 414 includes cleaning up the priority state table (e.g., by deleting and/or releasing computing resources allocated for the priority state table).

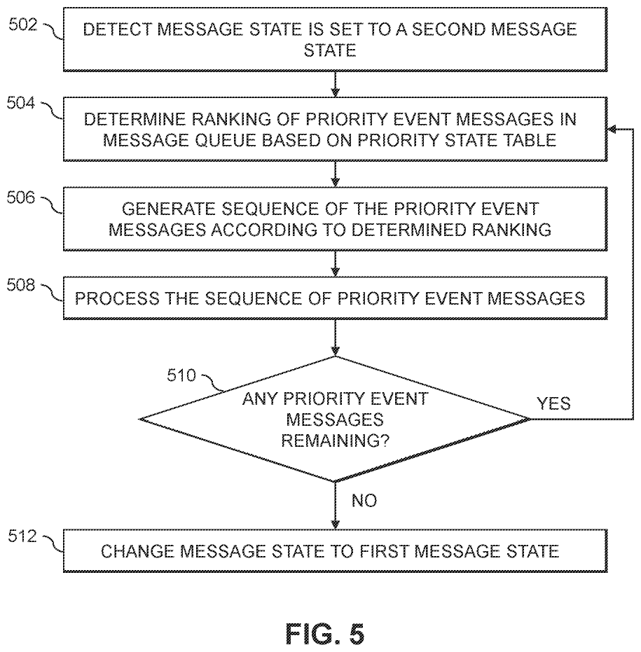

FIG. 5 shows a flow diagram for processing event messages in a first message state in accordance with an illustrative embodiment. The process depicted in FIG. 5 can be performed at least in part by the priority message consumer server 152 utilizing its sequencing logic 153, for example.

Step 502 includes detecting that a message state is set to a second state (e.g., in response to the state being changed by the priority state consumer server 154 in step 404).

Step 504 includes determining a ranking of the priority event messages in the message queue based on the priority state table.

Step 506 includes generating a sequence of the priority event messages according to the determined ranking.

Step 508 includes processing the sequence of priority event messages.

Step 510 includes a test to determine if any priority messages remain. For example, one or more additional priority event messages may be sent to the message queue, and the additional priority event messages need to be sequenced and processed at steps 504-508 accordingly.

If the result of step 510 is no (indicating the total number of pending priority event messages is zero), then step 512 is performed. Step 512 includes changing the message state to the first message state. In at least some embodiments, step 512 can further depend on a timer that is reset when a priority event message is received (e.g., at step 408 of FIG. 4). In such embodiments, the message state is changed to the first message state in response to there being no remaining priority event messages and the expiration of the timer.

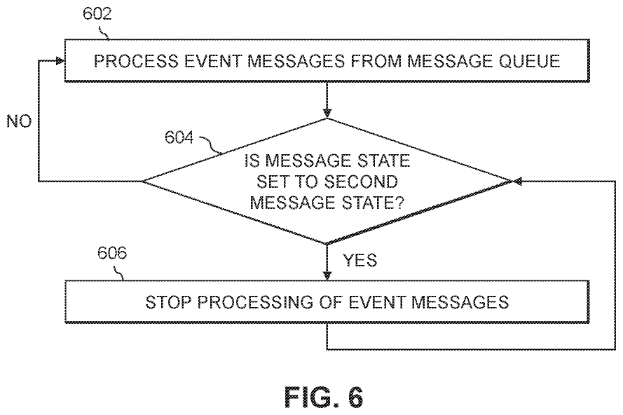

FIG. 6 shows a flow diagram for processing event messages in a second state in accordance with an illustrative embodiment. The process depicted in FIG. 6 can be performed at least in part by a given one of the message consumer servers 156 shown in FIG. 1, for example.

Step 602 includes processing event messages from the message queue. It is assumed that the message state is set to the first state, and the event messages being processed are not priority event messages.

Step 604 includes a test to determine whether the message state is set to the second state. If no, then the process returns to step 602 and continues processing event messages. If the result of step 604 is yes, then the step 606 is performed, which includes stopping processing of the event messages. The processing of the event messages remains stopped until the message state returns to the first message state.

Accordingly, some embodiments can provide an event-based system that is configured to determine priority rankings and prioritize messages based on a topic message that acts as a state altering mechanism. Additionally, at least some embodiments can enable a user to specify a particular priority order (e.g., based on a naming convention) and/or apply a default priority order (e.g., a round-robin order). Further, at least one embodiment can provide an early warning of upcoming alerts (e.g., manual/automated alerts)

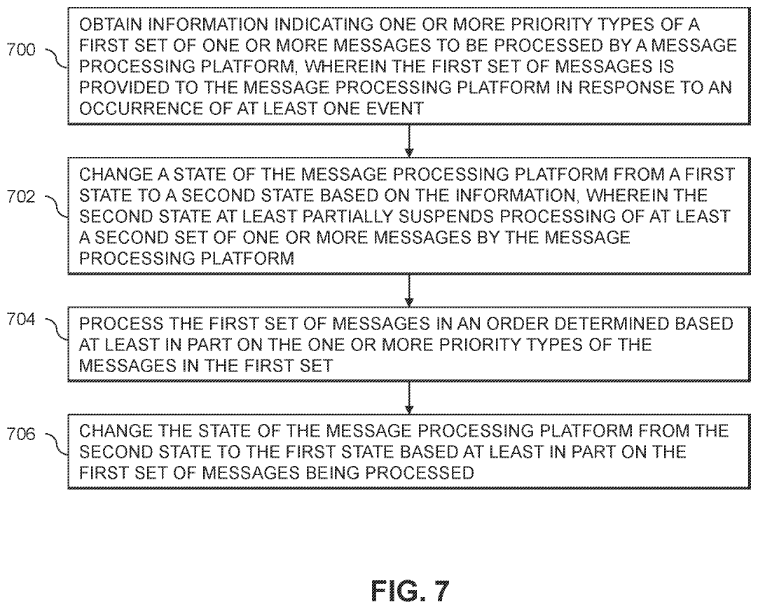

FIG. 7 shows a flow diagram of a process for prioritizing messages in event-based systems in an illustrative embodiment. It is to be understood that this particular process is only an example, and additional or alternative processes can be carried out in other embodiments. In this embodiment, the process includes steps 700 through 706.

Step 700 includes obtaining information indicating one or more priority types of a first set of one or more messages to be processed by a message processing platform, wherein the first set of messages is provided to the message processing platform in response to an occurrence of at least one event.

Step 702 includes changing a state of the message processing platform from a first state to a second state based on the information, wherein the second state at least partially suspends processing of at least a second set of one or more messages by the message processing platform.

Step 704 includes processing the first set of messages in an order determined based at least in part on the one or more priority types of the messages in the first set.

Step 706 includes changing the state of the message processing platform from the second state to the first state based at least in part on the first set of messages being processed.

Changing the state of the message processing platform from the second state to the first state may cause the second set of messages to be processed by the message processing platform. The one or more priority types may correspond to one or more planned outage events, one or more unplanned alert events, one or more password change events, one or more configuration change events, and/or one or more user events associated with one or more priority services from among a plurality of services. The process can further include a step of publishing the first set of messages to one or more topics of a message queue associated with the message processing platform based at least in part on the one or more priority types. The process can further include a step of maintaining, in response to the change from the first state to the second state, a data structure, where the data structure includes message counts and rankings for the one or more priority types, where a given one of the message counts may indicate a number of remaining messages in the first set of messages for the corresponding priority type to be processed. The data structure may be maintained by a message consumer of the message processing platform, the message consumer being subscribed to the one or more topics of the message queue associated with one or more of the priority types. For a given message in the first set, the information may identify one of a plurality of services that is a source of the given message, and the processing of the first set of messages may be based at least in part on the source of the given message.

Accordingly, the particular processing operations and other functionality described in conjunction with the flow diagram of FIG. 7 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve data consistency and increase overall system reliability relative by prioritizing processing of one or more types of event messages and temporarily preventing other types of events from being processed.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

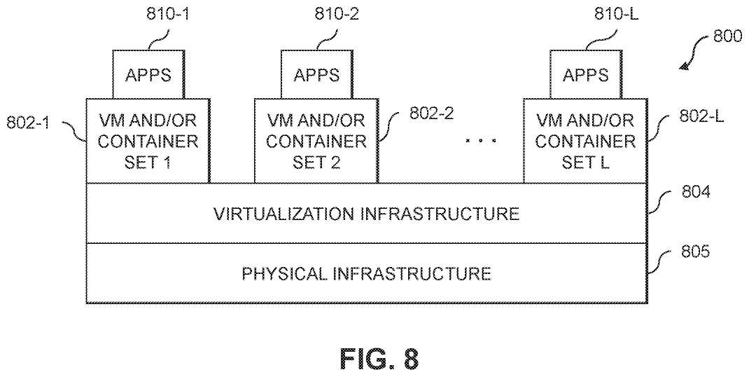

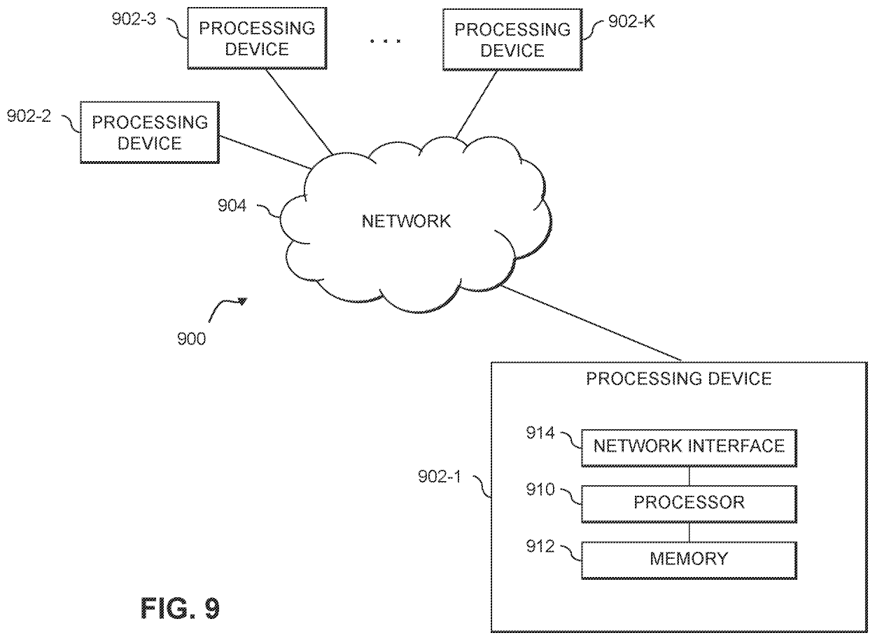

Illustrative embodiments of processing platforms will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that are utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 comprise respective VMs, respective sets of one or more containers, or respective sets of one or more containers running in VMs. In some implementations of the FIG. 8 embodiment, the VMs/container sets 802 comprise respective VMs implemented using virtualization infrastructure 804 that comprises at least one hypervisor.

A hypervisor platform may be used to implement a hypervisor within the virtualization infrastructure 804, wherein the hypervisor platform has an associated virtual infrastructure management system. The underlying physical machines comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 902-1 in the processing platform 900 comprises a processor 910 coupled to a memory 912.

The processor 910 comprises a microprocessor, a microcontroller, an ASIC, an FPGA or other type of processing circuitry, as well as portions or combinations of such circuitry elements.

The memory 912 comprises RAM, ROM or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining information indicating one or more priority types of a first set of one or more messages to be processed by a message processing platform, wherein the first set of messages is provided to the message processing platform in response to an occurrence of at least one event;
changing a state of the message processing platform from a first state to a second state based on the information, wherein the second state at least partially suspends processing of at least a second set of one or more messages by the message processing platform;
processing the first set of messages in an order determined based at least in part on the one or more priority types of the messages in the first set; and
changing the state of the message processing platform from the second state to the first state based at least in part on the first set of messages being processed;
wherein the method is performed by at least one processing device comprising a processor coupled to a memory.

2. The computer-implemented method of claim 1, wherein the changing the state of the message processing platform from the second state to the first state causes the second set of messages to be processed by the message processing platform.

3. The computer-implemented method of claim 1, wherein the one or more priority types correspond to at least one of:
one or more planned outage events;
one or more unplanned alert events;
one or more password change events;
one or more configuration change events; and
one or more user events associated with one or more priority services from among a plurality of services.

4. The computer-implemented method of claim 1, further comprising:
publishing the first set of messages to one or more topics of a message queue associated with the message processing platform based at least in part on the one or more priority types.

5. The computer-implemented method of claim 4, further comprising:
maintaining, in response to the change from the first state to the second state, a data structure, wherein the data structure comprises message counts and rankings for the one or more priority types, wherein a given one of the message counts indicates a number of remaining messages in the first set of messages for the corresponding priority type to be processed.

6. The computer-implemented method of claim 5, wherein the data structure is maintained by a message consumer of the message processing platform, the message consumer being subscribed to the one or more topics of the message queue associated with one or more of the priority types.

7. The computer-implemented method of claim 1, wherein, for a given message in the first set, the information identifies one of a plurality of services that is a source of the given message, and wherein the processing of the first set of messages is based at least in part on the source of the given message.

8. A non-transitory processor-readable storage medium having stored therein program code of one or more software programs, wherein the program code when executed by at least one processing device causes the at least one processing device:
to obtain information indicating one or more priority types of a first set of one or more messages to be processed by a message processing platform, wherein the first set of messages is provided to the message processing platform in response to an occurrence of at least one event;
to change a state of the message processing platform from a first state to a second state based on the information, wherein the second state at least partially suspends processing of at least a second set of one or more messages by the message processing platform;
to process the first set of messages in an order determined based at least in part on the one or more priority types of the messages in the first set; and
to change the state of the message processing platform from the second state to the first state based at least in part on the first set of messages being processed.

9. The non-transitory processor-readable storage medium of claim 8, wherein the changing the state of the message processing platform from the second state to the first state causes the second set of messages to be processed by the message processing platform.

10. The non-transitory processor-readable storage medium of claim 8, wherein the one or more priority types correspond to at least one of:
one or more planned outage events;
one or more unplanned alert events;
one or more password change events;
one or more configuration change events; and
one or more user events associated with one or more priority services from among a plurality of services.

11. The non-transitory processor-readable storage medium of claim 8, wherein the program code, when executed by the at least one processing device, further causes the at least one processing device:
to publish the first set of messages to one or more topics of a message queue associated with the message processing platform based at least in part on the one or more priority types.

12. The non-transitory processor-readable storage medium of claim 11, wherein the program code, when executed by the at least one processing device, further causes the at least one processing device:
to maintain, in response to the change from the first state to the second state, a data structure, wherein the data structure comprises message counts and rankings for the one or more priority types, wherein a given one of the message counts indicates a number of remaining messages in the first set of messages for the corresponding priority type to be processed.

13. The non-transitory processor-readable storage medium of claim 12, wherein the data structure is maintained by a message consumer of the message processing platform, the message consumer being subscribed to the one or more topics of the message queue associated with one or more of the priority types.

14. The non-transitory processor-readable storage medium of claim 12, wherein, for a given message in the first set, the information identifies one of a plurality of services that is a source of the given message, and wherein the processing of the first set of messages is based at least in part on the source of the given message.

15. An apparatus comprising:
at least one processing device comprising a processor coupled to a memory;
the at least one processing device being configured:
to obtain information indicating one or more priority types of a first set of one or more messages to be processed by a message processing platform, wherein the first set of messages is provided to the message processing platform in response to an occurrence of at least one event;
to change a state of the message processing platform from a first state to a second state based on the information, wherein the second state at least partially suspends processing of at least a second set of one or more messages by the message processing platform;
to process the first set of messages in an order determined based at least in part on the one or more priority types of the messages in the first set; and
to change the state of the message processing platform from the second state to the first state based at least in part on the first set of messages being processed.

16. The apparatus of claim 15, wherein the changing the state of the message processing platform from the second state to the first state causes the second set of messages to be processed by the message processing platform.

17. The apparatus of claim 15, wherein the one or more priority types correspond to at least one of:
one or more planned outage events;
one or more unplanned alert events;
one or more password change events;
one or more configuration change events; and
one or more user events associated with one or more priority services from among a plurality of services.

18. The apparatus of claim 15, wherein the at least one processing device is further configured:
to publish the first set of messages to one or more topics of a message queue associated with the message processing platform based at least in part on the one or more priority types.

19. The apparatus of claim 18, wherein the at least one processing device is further configured:
to maintain, in response to the change from the first state to the second state, a data structure, wherein the data structure comprises message counts and rankings for the one or more priority types, wherein a given one of the message counts indicates a number of remaining messages in the first set of messages for the corresponding priority type to be processed.

20. The apparatus of claim 19, wherein the data structure is maintained by a message consumer of the message processing platform, the message consumer being subscribed to the one or more topics of the message queue associated with one or more of the priority types.
